(19) United States
(12) Patent Application Publication
(10) Pub. No.: US 2010/0300604 A1
(43) Pub. Date: Dec. 2, 2010

(54) IMAGE TRANSFER BELT WITH CONTROLLED SURFACE TOPOGRAPHY TO IMPROVE TONER RELEASE

(76) Inventors: William Krebs Goss, Missouri City, TX (US); Chris Tice, Candler, NC (US); Jeff Jennings, Hendersonville, NC (US)

Correspondence Address: DINSMORE & SHOHL LLP, FIFTH THIRD CENTER, ONE SOUTH MAIN STREET, SUITE 1300, DAYTON, OH, 45402-2023, US

(21) Appl. No.: 12/474,319

(22) Filed: May 29, 2009

(51) Int. Cl. B32B 37/00; B31F 1/07

(52) U.S. Cl. 156/154; 156/209

(57) ABSTRACT

A three-layer image transfer belt having an uppermost surface that has been altered to reduce surface gloss and induce a desirable surface topography is presented. The image transfer belt can comprise a three layer laminate. In one embodiment, the base layer can be a polyimide, the intermediate layer can be a rubber/elastomer and the surface layer can be a fluoropolymer. In another embodiment, the base layer can also comprise a fabric for belt reinforcement. The desired surface topography improves toner release and print quality. The reduction of surface gloss of the image transfer belt is achieved by creating a linear pattern oriented in the machine direction or a grid-like pattern into the uppermost surface of the image transfer belt. The reduction of surface gloss of the image transfer belt is achieved without a significant change in surface rougheness.

### BACKGROUND OF THE INVENTION

The present invention generally is directed to an image transfer belt for use in a digital imaging system, and more particularly, to a three-layer image transfer belt for use in a digital imaging system with a controlled surface topography created through mechanical abrasion or embossing to improve toner release.

Digital imaging systems are widely used in the fields of xerography and electrography where dry or liquid toner is used to print text and graphic images. For example, systems which use digitally addressable writing heads to form latent images include laser, light-emitting diode, and electron beam printers. Copiers use optical means to form latent images. Regardless of how they are formed, the latent images are inked (or toned), transferred, and then fixed to a paper or polymer substrate. Such systems typically include a component such as an image transfer belt (ITB) which is utilized for latent image recording, intermediate image transfer (transfer of a toner image to the belt followed by transfer to a substrate), transfusing of toner (transport of the unfused image onto the belt with subsequent fusing), contact fusing, or electrostatic and/or frictional transport of imaging substrates such as paper, transparencies, etc.

Efforts in the past have been made to develop ITBs with increasingly smooth, flat print faces with the intention of improving toner release and print quality. However, these ITBs produced contrary results. It was observed that highly smooth, highly flat print faces tended to hold toner due to increased surface area of contact between the ITB surface and toner particles. Prior approaches to improving toner release and print quality of ITBs used topographical variation of the uppermost surface of the ITB to induce an increase surface roughness. These approaches increased surface roughness by randomly inducing particulate fillers or additives to the uppermost surface to create a bumpy surface or by randomly roughening the uppermost surface by, for example, sandblasting.

However, there remains a need in the art to improve toner release from an ITB without significantly changing surface roughness of the belt.

### BRIEF SUMMARY OF THE INVENTION

The present invention provides a three-layer image transfer belt having an uppermost surface that has been altered to reduce surface gloss without a significant change in surface roughness to produce a desirable surface topography for improving both toner release and print quality. By “surface gloss,” we mean the amount of light reflected when the angle of illumination equals the angle of reflection. By “surface roughness,” we mean the centerline average height (Ra) and averaged depth of roughness (Rz) as measured by DIN 4768. The image transfer belt can comprise a three layer laminate. The base layer can be a polyimide, the intermediate layer can be a rubber/elastomer and the upper, or surface, layer can be a fluoropolymer. The base layer can also comprise a fabric for belt reinforcement.

In accordance with one embodiment of the present invention, the improvement of toner release of the image transfer belt is achieved by creating a pattern of linear grooves generally oriented in the machine direction into the uppermost surface of the image transfer belt. By “linear grooves,” we mean grooves that are uniform in length, width and depth or random in length, width and depth and which may be parallel, skewed or crossing.

In accordance with another embodiment of the present invention, the improvement of toner release of the image transfer belt is achieved by creating a grid-like pattern of grooves into the uppermost surface of the image transfer belt.

In accordance with yet another embodiment of the present invention, the improvement of toner release of the image transfer belt is achieved without a significant change in surface roughness of the image transfer belt.

Accordingly, it is a feature of the embodiments of the present invention to mechanically abrade or emboss the uppermost surface of a three-layer image transfer belt to produce a patterned surface topography which improves toner release and, in turn, improves print quality without a significant change in roughness of the uppermost surface of the image transfer belt. Other features of the embodiments of the present invention will be apparent in light of the following description of the invention embodied herein, the accompanying drawings, and the appended claims.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 illustrates a side view of a three layer image transfer belt according to an embodiment of the present invention;

FIG. 2 is a perspective view of one embodiment of the image transfer belt of the present invention mounted on rotational rollers;

FIG. 3 is a perspective view of the image transfer belt of FIG. 2 according to an embodiment of the present invention;

FIG. 4 is an overhead view of the linear pattern uppermost surface of the image transfer belt of FIG. 2 according to an embodiment of the present invention; and

FIG. 5 is an overhead view of the grid-like pattern uppermost surface of the image transfer belt of FIG. 2 according to an embodiment of the present invention.

### DETAILED DESCRIPTION

In the following detailed description of the embodiments, reference is made to the accompanying drawings that form a part hereof, and in which are shown by way of illustration, and not by way of limitation, specific embodiments in which the invention may be practiced. It is to be understood that other embodiments may be utilized and that logical, mechanical and electrical changes may be made without departing from the spirit and scope of the present invention.

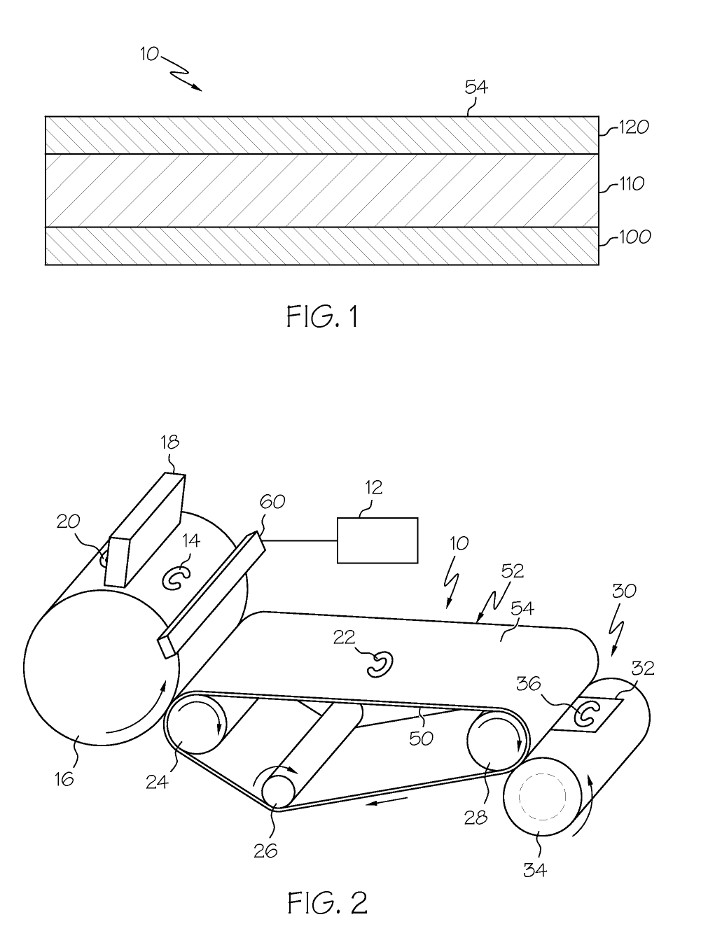

Referring now to FIG. 1, a side view of a image transfer belt 10 made according to the present invention is illustrated. The image transfer belt 10 can be comprised of three layers, 100, 110, 120 having an uppermost, or outermost, surface 54. A base layer 100 can provide strength required for the image transfer belt 10 to function in the printing presses. In one embodiment, the base layer 100 can be comprised of a polyimide film, such as, for example, Apical, Kapton or Kaptrex. In another embodiment, the base layer 100 may be comprised of silicone, fluorosilicone, fluorocarbon, EPDM, EPM, nitrile (NBR), epichlorohydrin (ECO) or urethane. The base layer 100 can have a thickness of between about 3 to about 3.5 mil (or between about 0.08 to about 0.09 mm). The volume resistivity of the base layer 100 can be adjusted to have a value of between about 10⁹ to about 10¹³ ohm-cm by blending an electrically conductive material such as, for example, carbon black metal salts, conductive polymers, conductive plasticisers, or any suitable material, into the polymer of the base layer 100.

In another embodiment, the base layer 100 may also comprise woven or non-woven fabric which can provide transverse strength as well as latitudinal and circumferential reinforcement to the belt. The base layer 100 may also be used to impart electrical and thermal conductivity characteristics to the image transfer belt 10 construction. In one embodiment, the base layer 100 can also be impregnated with elastomers. In one embodiment, the impregnation of the base layer 100 may be complete. In another embodiment, the base layer 100 can be partially impregnated. In still another embodiment, the base layer 100 may be provided as a pre-impregnated woven or non-woven fabric. In another embodiment, the impregnation of the base layer 100 may be accomplished as a process step within the image transfer belt construction.

In this embodiment, the fabric of the base layer 100 may comprise electrically and thermally conductive and/or non-conductive materials such as, for example, high temperature resistant aramid fibers, nylons, polyester, cotton, carbon fiber, Nomex, fiberglass, various metal and metal-coated fibers and polyphenylenebenzobisoxazole (PBO). These materials can be selected for electrical and/or thermal conductivity and may or may not be oriented within the base layer 100 structure. Preferably, the fabrics can be oriented in the machine direction and can serve to increase load at failure as well as increase modulus while reducing the necessary amount of fabric for equivalent properties. Machine orientations of 3-4 to 1 are preferable. Additionally, the woven or non-woven fabrics can be calendared prior to use in order to improve gauge uniformity and to reduce loose fiber show-through, thereby reducing the total cross-sectional space required for the fabric. Further, the lengthwise ends of the fabric of the base layer 100 can be tapered in thickness, weight or density such that when two tapered ends overlap at a splice, the cumulative thickness, weight or density can maintain uniformity and functional seamlessness within the belt circumference. The base layer 100 can have a thickness of between about 6 to about 10 mil (or between about 0.15 to about 0.25 mm).

An intermediate layer 110 can be laminated to the base layer 100 using a conductive primer or any other suitable method known in the art. The intermediate layer 110 can provide softness, or compliance, for optimum toner transfer. Additionally, the intermediate layer 110 can serve to isolate the electrical properties of the base layer 100 from an upper surface 120. In one embodiment, the intermediate layer can comprise an elastomer or a compliant rubber having a Shore A hardness of about 40-55. The volume resistivity of the intermediate layer 110 can be adjusted to be from about 10⁷ to about 10¹⁰ ohm-cm, also using an electrically conductive additive, such as, for example, carbon black, metal salts, conductive polymers, conductive plasticisers, or any suitable material. In one exemplary embodiment, the electrical properties of the intermediate layer 110 may be different that the electrical properties of the base layer 100 in order to provide optimum belt electrical properties resulting in the best printing outcomes. The intermediate layer 110 can have a thickness of about 0.20 to about 0.45 mm.

Finally, the upper layer 120 can be laminated to the intermediate layer 110 by any suitable method known in the art. In one embodiment, the upper layer 120 can comprise an insulative or semi-conductive material such as, for example, a fluoropolymer resin. Examples of fluoropolymer resins that may be used are polyvinylidene fluoride (PVDF), fluorinated ethylene propylene (FEP), perfluoroalkoxy (PFA) or any other suitable fluoropolymer resin. In another embodiment, the upper layer 120 may be comprised of silicone, fluorosilicone, fluorocarbon, EPDM, EPM, nitrile (NBR), epichlorohydrin (ECO) or urethane. An electrically conductive material such as, for example, carbon black, metal salts, conductive polymers, conductive plasticisers, or any suitable material, may also be added to adjust the conductivity. The upper layer 120 can have a thickness of about 0.003-0.012 mm. Additionally, the upper layer 120 can be mechanically abraded to control toner release as will be discussed below. The image transfer belt 10 can be made as a flat sheet and then seamed together using a seam adhesive to form the image transfer belt 10 using technology known in the art. The seam adhesive can be a conductive polymer. The total overall thickness of the belt 10 can be about 0.3 to about 0.6 mm.

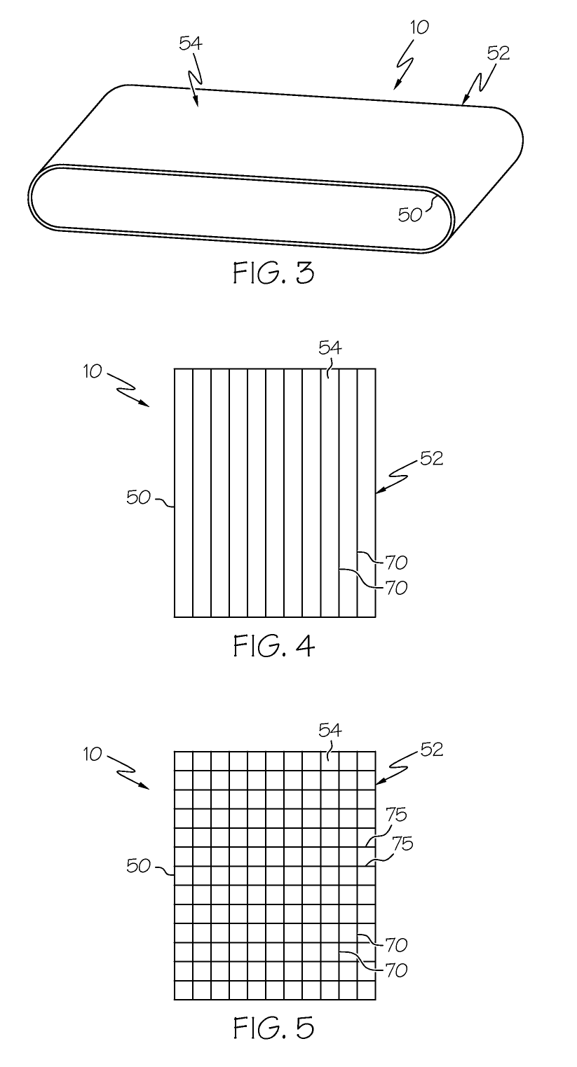

Referring to the embodiment shown in FIG. 2, the image transfer belt 10 can further comprise a first edge 50 and a second edge 52. The image transfer belt 10 can be used for intermediate image transfer. In other applications, the image transfer belt 10 may be used on a recording drum such as the recording drum 16 shown in FIG. 3. Initially, a computer, or processor, 12 can control the formation of a latent image 14 via a writing head 60 (such as a laser or LED, for example) onto a recording drum 16. The latent image can electrostatically attract dry toner from a toner cartridge 18 to form a toned, unfused image 20. This image can then be transferred to the uppermost surface 54 of the image transfer belt 10 in the form of an intermediate image 22. The image transfer belt 10 may be driven by rollers 24, 26 and 28 which advance the intermediate image through a transfusing nip 30 where heat and pressure can be applied to simultaneously transfer and fuse the toner image onto a substrate 32 which can be synchronously and frictionally advanced by fusing roller 34 and image transfer belt 10 to form the final, fused image 36. It should be appreciated that latent image 14, unfused image 20, intermediate image 22 and fused image 36 are shown in such a way as to better illustrate the sequence of steps involved in forming an image. For example, in the actual process, transfer and fusing of image 36 onto substrate 32 actually occurs at nip 30. The above-described process can also be adapted for use with liquid toner.

In one embodiment, the uppermost surface 54 of the image transfer belt 10 can be mechanically abraded to induce a desirable surface topography into the uppermost surface 54. This surface topography can improve toner release from the image transfer belt 10 as well as improves print quality. In one embodiment, the preferred surface topography can be a pattern of substantially linear grooves 70 oriented generally in the machine direction which can be abraded into the uppermost surface 54 the image transfer belt 10 as illustrated in FIG. 4. These linear grooves 70 can be uniformly or randomly abraded into the uppermost surface 54. Further, the linear grooves 70 can be abraded parallel, skewed, or crossing to each other. In another embodiment, addition across-direction grooves 75 can be abraded perpendicular to the linear grooves 70 into the uppermost surface 54 of the image transfer belt 10 yielding a cumulative cross-hatch or grid-like pattern as illustrated in FIG. 5.

Dimensions of the grooves 70 are such that a difference in light scatter can be readily measured between surfaces before and after mechanical abrasion. The light scatter may be measured with, for example a Lasercheck® instrument sold by Optical Dimensions LLC of Santa Ana, Calif. The light scatter of the uppermost surface 54 can be increased by at least approximately 20% relative to the light scatter prior to abrasive patterning of the uppermost surface 54 of the image transfer belt 10.

In one embodiment, the desired surface topography can be imparted into the uppermost surface 54 of the image transfer belt 10 by brushing the image transfer belt 10 with stationary, oscillating or rotating brushes or by many other mechanical processes such as, for example, cylindrical, belt, wheel, or blown-media grinding, buffing, polishing or abrading. The appropriate media that can be used includes paper, film, woven, or non-woven sheets or belts; stone; diamond; and synthetic abrasives. In another embodiment, the desirable surface topography can be imparted on the outermost surface 54 by contacting the outermost surface 54 of a rotating the image transfer belt 10 with a rotating nylon bristle brush. In yet another embodiment, the outermost surface 54 of the image transfer belt 10 can be contacted with a cellulose fabric material to impart the desired surface topography.

In another embodiment, the desired surface topography imparted with the desired and useful surface roughness or texture can be induced to the outermost surface 54 of the image transfer belt 10 by embossing the outermost surface 54 prior to full material cure with a texture roll. This embossing texture roll can be designed such that controlled grooves can be linearly patterned on the outermost surface 54 of the image transfer belt 10 when the roll is passed over and in contact with the image transfer belt 10. After curing, the linear grooves are permanently embossed into the uppermost surface 54 of the image transfer belt 10.

The imparted surface topography on the uppermost surface 54 of the image transfer belt 10 does not appreciably change the surface roughness (i.e., both Ra and Rz remain substantially the same after abrading or embossing the uppermost surface 54) of the uppermost surface 54 of the image transfer belt 10. Because the size of the abrasion/embossment is relatively small compared to the original surface roughness, the abrasion/embossment roughness can be maintained. The gloss level of the image transfer belt 10, however, can be reduced by as much as approximately 30% by using this technique. It should be noted that a preferred surface topography imparted by this technique can be highly linear and oriented in the machine direction as opposed to simply random abrasion patterns, such as, for example, circles from prior art techniques such as sandblasting. The surface roughness can have a Ra preferably in the range of about 0.05 to about 0.3 microns. Ra and Rz can be measured by surface profile instruments by methods well known in the art. For example, a suitable method measuring Ra and Rz is documented in DIN 4768. The surface gloss can have a 20° gloss in the range of about 2 to about 10. Suitable methods for measuring gloss are provided by ASTM D2457 and ASTM D523, as known in the art.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. An image transfer belt for use in a digital imaging system having a first edge and a second edge, the image transfer belt comprising:
a base layer comprised of a polyimide film;
an intermediate layer laminated to the base layer, the intermediate layer comprised of a compliant rubber/elastomer; and
an upper layer laminated to the intermediate layer, the semi-conductive upper layer comprised of a fluoropolymer resin, wherein the uppermost surface of the upper layer is patterned with linear grooves oriented in the machine direction.

2. The image transfer belt of claim 1, wherein the base layer has a thickness of between about 0.08 to 0.25 mm.

3. The image transfer belt of claim 1, wherein volume resistivity of the base layer is between about 10⁹ to about 10¹³ ohm-cm.

4. The image transfer belt of claim 1, wherein the intermediate layer has a thickness of between about 0.20 to 0.45 mm.

5. The image transfer belt of claim 1, wherein volume resistivity of the intermediate layer is between about 10⁷ to about 10¹⁰ ohm-cm.

6. The image transfer belt of claim 1, wherein the upper layer has a thickness of between about 0.003 to 0.012 mm.

7. The image transfer belt of claim 1, wherein the fluoropolymer resin comprises polyvinylidene fluoride, fluorinated ethylene propylene, perfluoroalkoxy, or combinations thereof.

8. The image transfer belt of claim 1, wherein the image transfer belt has a overall thickness of about 0.5 mm.

9. The image transfer belt of claim 1, wherein volume resistivity of the base layer, intermediate layer and the semi-conductive upper layer is adjusted by adding a electrically conductive material.

10. The image transfer belt of claim 9, wherein the electrically conductive material is carbon black.

11. The image transfer belt of claim 9, wherein the electrically conductive material comprises metal salts.

12. The image transfer belt of claim 9, wherein the electrically conductive material comprises conductive polymers or conductive plasticisers.

13. The image transfer belt of claim 1, wherein the linear grooves are uniformly patterned between the first and second edges.

14. The image transfer belt of claim 1, wherein the linear grooves are randomly patterned between the first and second edges.

15. The image transfer belt of claim 1, wherein the linear grooves are patterned substantially parallel to the first and second edges.

16. The image transfer belt of claim 1, wherein the linear grooves are patterned substantially perpendicular to the first and second edges.

17. The image transfer belt of claim 1, wherein the linear grooves are patterned such that the linear grooves are skewed between the first and second edges.

18. The image transfer belt of claim 1, wherein the linear grooves are patterned substantially parallel and substantially perpendicular to the first and second edges to form a grid-like pattern.

19. The image transfer belt of claim 1, having a surface roughness in the range of about 0.05 microns to about 0.3 microns.

20. The image transfer belt of claim 1, having a 20° surface gloss in the range of about 2 to about 10.

21. The image transfer belt of claim 1, wherein the surface gloss is reduced by at least 30% when compared with a non-patterned uppermost surface.

22. The image transfer belt of claim 1, wherein light scatter of the upper layer is increased by at least about 20% relative to the light scatter prior to patterning of the upper surface.

23. An image transfer belt for use in a digital imaging system having a first edge and a second edge, the image transfer belt comprising:
a base layer comprised of a fiber reinforced polymer;
an intermediate layer laminated to the base layer, the intermediate layer comprised of a compliant rubber/elastomer; and
an upper layer laminated to the intermediate layer, the semi-conductive upper layer comprised of a fluoropolymer resin, wherein the uppermost surface of the upper layer is patterned with linear grooves oriented in the machine direction.

24. A method of fabricating an image transfer belt for use in a digital imaging system, the method comprising:
forming the image transfer belt by providing a base layer, laminating an intermediate layer to the base layer and laminating a semi-conductive upper layer to the intermediate layer, wherein the image transfer belt has a first and second edges and an uppermost surface; and
linearly patterning grooves into the uppermost surface while not increasing surface roughness to improve the toner release properties of the image transfer belt.

25. The method of claim 24, further comprising:
rotating the image transfer belt;
contacting the rotating image transfer belt with a rotating brush to create the linear pattern.

26. The method of claim 24, further comprising:
rotating the image transfer belt;
contacting the rotating image transfer belt with a cellulose fabric material to create the linear pattern.

27. The method of claim 24, further comprising:
patterning additional grooves into the uppermost surface at a cross direction to the linear grooves to create a substantially grid-like pattern in the uppermost surface.

28. The method of claim 24, wherein the linearly grooves are patterned by mechanically abrading the uppermost surface.

29. The method of claim 24, wherein the linearly grooves are patterned by embossing the uppermost surface before curing.

30. The method of claim 24, wherein the linearly grooves are patterned by embossing the uppermost surface with an embossing roll.

31. The method of claim 24, wherein the patterning is imparted into the uppermost surface by brushing with stationary brushes, oscillating brushes, rotating brushes, or combinations thereof.

32. The method of claim 24, wherein the patterning is imparted into the uppermost surface by cylindrical, belt, wheel, or blown-media grinding, buffing, polishing, abrading or combinations thereof.

33. The method of claim 32, wherein the blown-media comprises paper, film, woven sheets, woven belts, non-woven sheets, non-woven belts, stone, diamond, synthetic abrasives, or combinations thereof.

34. A method of fabricating an image transfer belt for use in a digital imaging system, the method comprising:
forming the image transfer belt by providing a polyimide film base layer, laminating a compliant rubber intermediate layer to the polyimide film base layer and laminating a fluoropolymer resin upper layer to the compliant rubber intermediate layer, wherein the image transfer belt has a first and second edges and an uppermost surface; and
linearly patterning grooves into the uppermost surface while not increasing surface roughness to improve the toner release properties of the image transfer belt.
